(19) United States
(12) Patent Application Publication
(10) Pub. No.: US 2022/0261507 A1
(43) Pub. Date: Aug. 18, 2022

(54) SECURE COMPUTATION SERVER, TRAIL MANAGEMENT METHOD, AND PROGRAM

(71) Applicant: NEC Corporation, Minato-ku, Tokyo (JP)

(72) Inventors: Hikaru TSUCHIDA, Tokyo (JP); Kazuma OHARA, Tokyo (JP); Toshinori ARAKI, Tokyo (JP); Takuma AMADA, Tokyo (JP)

(73) Assignee: NEC Corporation, Minato-ku, Tokyo (JP)

(21) Appl. No.: 17/628,953

(22) PCT Filed: Jul. 24, 2019
(86) PCT No.: PCT/JP2019/029029

§ 371 Date: Jan. 21, 2022

(51) Int. Cl. G06F 21/64; H04L 9/00; H04L 9/08

(52) U.S. Cl. CPC G06F 21/64; H04L 2209/46; H04L 9/085; H04L 9/50

(57) ABSTRACT

A secure computation server includes: a computation processing part that performs secure computation by using data x received from a client and computes a computation result R; and a trail registration part that makes a predetermined trail storage system to store first trail data for certifying identity of the data x, the first trail data having been calculated from the data x, and second trail data for certifying a relationship between the data x and the computation result R. The predetermined trail storage system manages the first and second trail data in a non-rewritable manner and provides the first and second trail data to a predetermined audit node.

This application is a National Stage Entry of PCT/JP2019/029029 filed on Jul. 24, 2019, the contents of all of which are incorporated herein by reference, in their entirety.

### FIELD

The present invention relates to a secure computation server, a trail management method, and a program.

### BACKGROUND

Data utilization businesses are active in information banks, data exchange markets, etc. In this kind of data utilization businesses, a blockchain (which will also be referred to as a “BC”) technology is an example of a mechanism of controlling data utilization of companies to which data is provided.

Since these data include personal information, privacy protection is also required. A multi-party computation (which will also be referred to as “MPC”) technology is known as a technique to obtain an output by processing data in secret. PTL 1 discloses a secret computation system that perform data processing while keeping personal information secret.

PTL2 discloses an electronic certification system that guarantee the reliability of data provided to a second terminal apparatus such as a client from a first terminal apparatus such as a server, which uses a trail registered in a blockchain. Specifically, the first terminal apparatus in PTL 2 includes trail registration means for registering data and information about the first terminal apparatus in a blockchain as a trail. In addition, this first terminal apparatus includes trail provision means for transmitting a trail to the second terminal apparatus. If the trail provided from the trail provision means is registered in the blockchain, the second terminal apparatus determines that the corresponding data is reliable.

NPL1 discloses a distributed computation platform on which various parties perform computation of data or the like in cooperation with each other while keeping the data secret by combining the MPC and BC.

NPL 2 discloses a configuration for ensuring fairness among parties regarding the MPC by combining the MPC and BC.
PTL1: International Publication No. 2015/114947
PTL2: Japanese Unexamined Patent Application No. 2018-182487
NPL1: Guy Zyskind, et al., “Enigma: Decentralized Computation Platform with Guaranteed Privacy”, [online], [searched on Jun. 4, 2019], Internet <URL:https://arxiv.org/pdf/1506.03471.pdf>
NPL2: Arka Rai Choudhuri, et al., “Fairness in an Unfair World: Fair Multiparty Computation from public Bulletin Boards”, [online], [searched on Jun. 4, 2019], Internet <URL:https://eprint.iacr.org/2017/1091.pdf>

### SUMMARY

The following analysis will be hereinafter made based on the present invention. By using the configuration as disclosed in PTL 1, it is possible to have the secure computation system perform computation while keeping data secret and to transfer only the computation result to the corresponding user terminal that is to use the data. However, in this configuration as disclosed in PTL 1 in which various data processing is performed without restoring personal information included in data, that is, while keeping the personal secret, there is a possibility that a registerer terminal that provides data could register inappropriate data with some intention. For example, if a terminal has modified data such that a statistical result calculated by secure computation would be advantageous for the terminal, it is difficult to detect this modification in real time due to the nature of secure computation. Thus, a mechanism of retroactively verifying the correctness is needed.

In accordance with the method disclosed in PTL2, information about the first terminal apparatus and trail data are registered as a set in a blockchain. However, information handled by a secure computation system needs to be kept secret, and the method disclosed in PTL 2 cannot be adopted.

It is an object of the present invention to provide a secure computation server, a trail management method, and a program that contribute to facilitation of the verification of the correctness of secure computation target data.

According to a first aspect, there is provided a secure computation server, including: a computation processing part that performs secure computation by using data x received from a client and computes a computation result R; and a trail registration part that makes a predetermined trail storage system store first trail data and second trail data, wherein the first trail data is calculated from the data x for certifying identity of the data x and the second trail data certifies a relationship between the data x and the computation result R.

According to a second aspect, there is provided a trail storage system, including: a trail data creation part that creates first trail data for certifying identity of the data x and second trail data for certifying a relationship between data x and computation result R, based on data received from secure computation servers; and a trail data management part that manages the first and second trail data in a non-rewritable manner and provides the first and second trail data to a predetermined audit node, wherein each of the secure computation servers includes a computation processing part that performs secure computation by using the data x received from a client and computes the computation result R and a trail registration part that makes a predetermined trail storage system store first trail data and second trail data, wherein the first trail data is calculated from the data x for certifying identity of the data x and the second trail data certifies a relationship between the data x and the computation result R.

According to a third aspect, there is provided a secure computation trail management method, including: causing a secure computation server to transmit data for computing first trail data for certifying identity of data x and second trail data for certifying a relationship between the data x and computation result R to a predetermined trail storage system; and causing the predetermined trail storage system to store the first trail data and the second trail data, wherein the secure computation server includes a computation processing part that performs secure computation by using the data x received from a client and computes the computation result R. This method is associated with a certain machine, which is the secure computation server that makes the predetermined trail storage system store the first and second trail data.

According to a fourth aspect, there is provided a secure computation trail management method, including: receiving data for computing first trail data for certifying identity of data x and second trail data for certifying a relationship between the data x and computation result R from a secure computation server that includes the computation processing part that performs secure computation by using data x received from a client and computes the computation result R; creating the first trail data and the second trail data based on the received data; and managing the first trail data and the second trail data in a non-rewritable manner and providing the first trail data and the second trail data to a predetermined audit node. This method is associated with a certain machine, which is a trail storage system that creates the first and second trail data and provides the first and second trail data to a predetermined audit node.

According to a fifth aspect, there is provided a program for realizing a function of the above secure computation server or trail storage system. The program is inputted to a computer apparatus from an input device or an external node via a communication interface, is stored in a storage device, and causes a processor to drive in accordance with predetermined steps or processing. In addition, as needed, this program can display a processing result including an intermediate state per state on a display device or can communicate with an external node via a communication interface. For this purpose, the computer apparatus typically includes, for example, a processor, a storage device, an input device, a communication interface, and as needed, a display device, which can be connected to each other via a bus.

The present invention contributes to facilitation of the verification of the correctness of secure computation target data.

### BRIEF DESCRIPTION OF THE DRAWINGS

FIG. 1 is a drawing illustrating a configuration according to an example embodiment of the present invention.

FIG. 2 is a drawing illustrating an operation (distribution of shares) according to the example embodiment of the present invention.

FIG. 3 is a drawing illustrating an operation (transmission of computation results) according to the example embodiment of the present invention.

FIG. 4 is a drawing illustrating an operation (transmission of shares) according to the example embodiment of the present invention.

FIG. 5 is a drawing illustrating an operation (audit) according to the example embodiment of the present invention.

FIG. 6 is a drawing illustrating a configuration according to a first example embodiment of the present invention.

FIG. 7 is a functional block diagram illustrating a detained configuration according to the first example embodiment of the present invention.

FIG. 8 is a sequence diagram illustrating an operation according to the first example embodiment of the present invention.

FIG. 9 is a sequence diagram illustrating an operation according to the first example embodiment of the present invention.

FIG. 10 is a drawing illustrating a configuration according to a second example embodiment of the present invention.

FIG. 11 is a sequence diagram illustrating an operation according to the second example embodiment of the present invention.

FIG. 12 is a sequence diagram illustrating an operation according to the second example embodiment of the present invention.

FIG. 13 is a diagram illustrating a configuration of a computer constituting a secure computation server or a trail storage system according to the present invention.

### PREFERRED MODES

First, an outline of an example embodiment of the present invention will be described with reference to drawings. In the following outline, various components are denoted by reference characters for the sake of convenience. That is, the following reference characters are merely used as examples to facilitate understanding of the present invention. Thus, the description of the outline is not meant to limit the present invention to the illustrated modes. An individual connection line between blocks in the drawings, etc. referred to in the following description signifies both one-way and two-way directions. An arrow schematically illustrates a principal signal (data) flow and does not exclude bidirectionality. A program is executed via a computer apparatus, and the computer apparatus includes, for example, a processor, a storage device, an input device, a communication interface, and as needed, a display device. In addition, this computer apparatus is configured to communicate with a device therein or an external node (including a computer) via the communication interface in a wired or wireless manner. In addition, while a port or an interface is present at an input/output connection point of an individual block in the drawings, illustration of the port or the interface is omitted. In addition, in the following description, “A and/or B” signifies at least one of A and B.

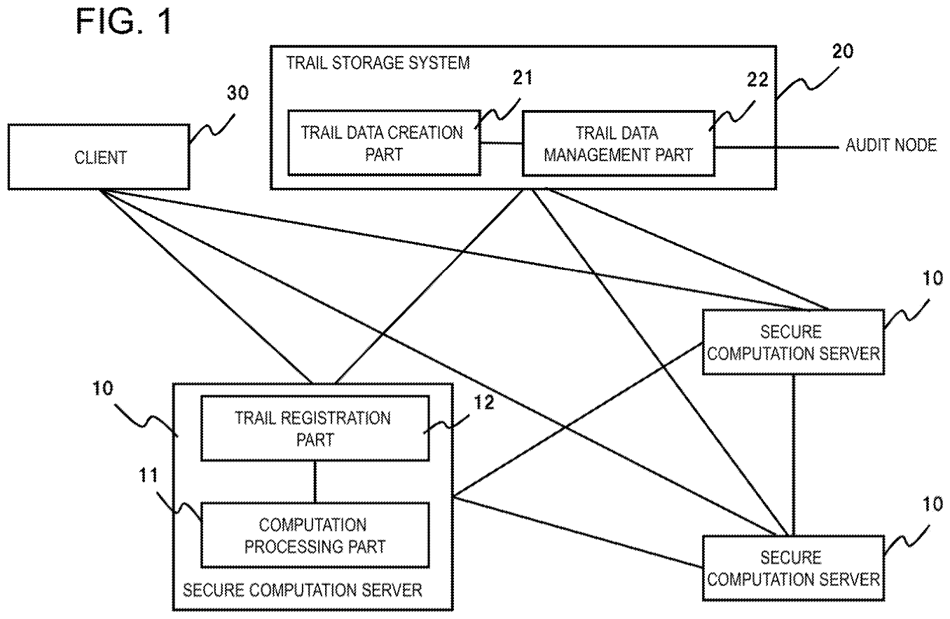

As illustrated in FIG. 1, an example embodiment of the present invention can be realized by a configuration including a plurality of secure computation servers 10 and a trail storage system 20. More specifically, the individual secure computation server 10 includes a computation processing part 11 and a trail registration part 12. The computation processing part 11 performs secure computation by using data x received from a client and computes a computation result R. For example, if a secret sharing method is used as the secure computation method, an individual secure computation server 10 performs secure computation based on a share of data x received from a client 30 in cooperation with the other secure computation servers 10 and computes a share of a computation result R. Next, the trail registration part 12 makes a predetermined trail storage system 20 store first trail data for certifying identity of the data x, the first trail data having been calculated from the data x, and second trail data for certifying a relationship between the data x and the computation result R. For example, if a secret sharing method is used as the secure computation method, the trail registration part 12 transmits a share of a hash value of the data x and a share of a value in which the data x and the computation result R are concatenated to the trail storage system 20. In this way, the individual secure computation server 10 makes the predetermined trail storage system store first trail data for certifying identity of the data x, the first trail data having been calculated from the data x, and second trail data for certifying a relationship between the data x and the computation result R.

The trail storage system 20 includes a trail data creation part 21 and a trail data management part 22. The trail data creation part 21 creates first trail data for certifying identity of the data x and second trail data for certifying a relationship between the data x and the computation result R, based on the data received from the secure computation servers 10. For example, the secure computation servers 10 transmit a set of shares of hash values of the data x and a set of shares of hash values of values, in each of which the corresponding data x and the corresponding computation result R are concatenated. In this case, based on these received data, the trail data creation part 21 creates first trail data for certifying identity of the data x and second trail data for certifying a relationship between the data x and the computation result R. Next, the trail data management part 22 manages the first and second trail data in a non-rewritable manner and provides the first and second trail data to a predetermined audit node.

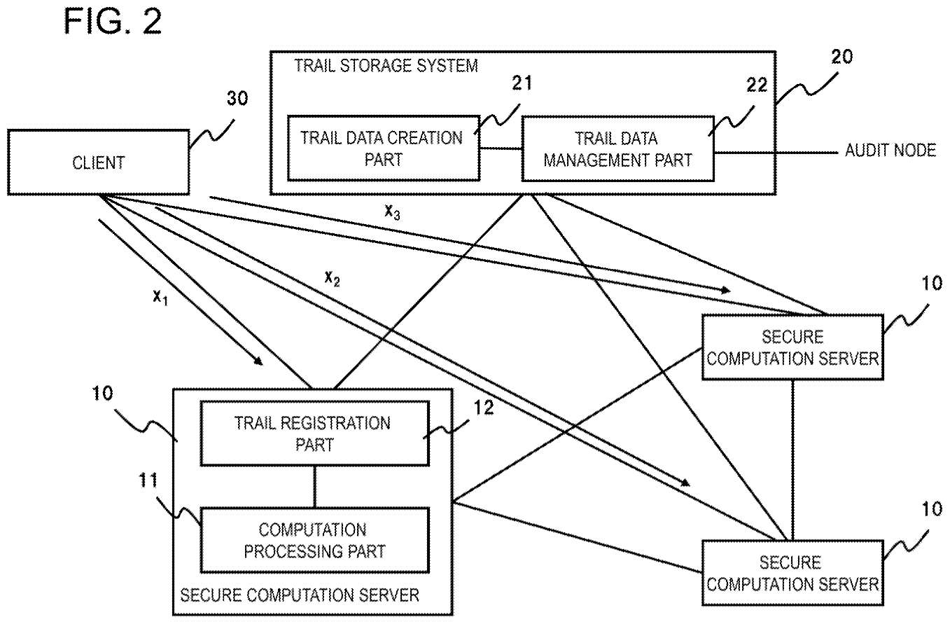

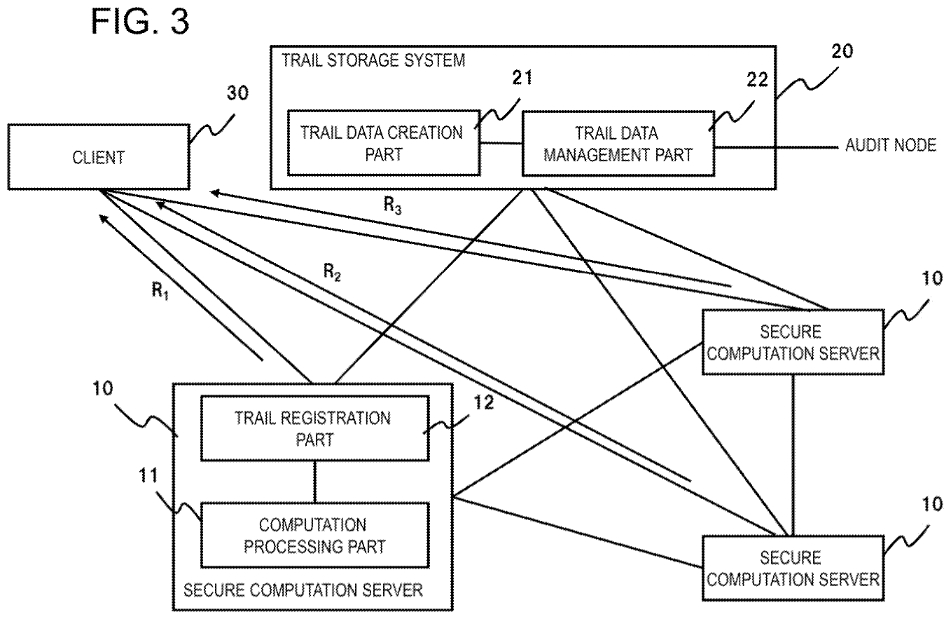

For example, when three parties perform secure computation, the first and second trail data will be created as follows. As illustrated in FIG. 2, the client 30 creates shares x₁, x₂, and x₃ of the data x and requests the secure computation servers 10 to perform computation. When receiving the requests, the secure computation servers 10 transmit their respective computation results R₁, R₂, and R₃ to the client 30, as illustrated in FIG. 3. The client 30 restores a computation result R from the computation results R₁, R₂, and R₃. In this way, the client 30 can obtain the computation result R while keeping the data x secret.

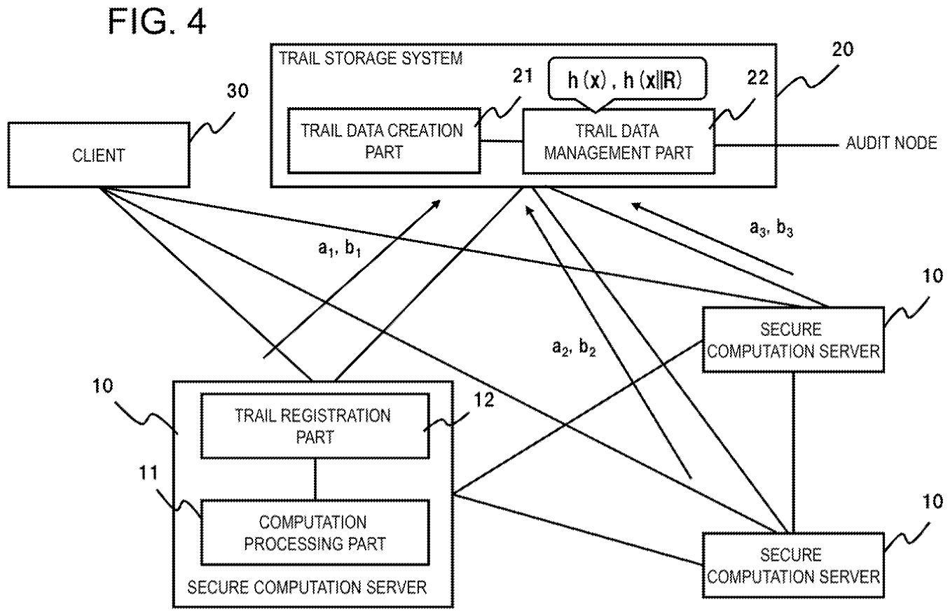

The individual secure computation servers 10 according to the present example embodiment calculate hash values of the data x, in addition to the above operation. As illustrated in FIG. 4, the secure computation servers 10 compute shares (for example, a₁, a₂, and a₃) of the hash values of their respective data x and shares b₁, b₂, and b₃ of the hash values h(x∥R) of values, in each of which the corresponding data x and the corresponding computation result R are concatenated, and transmit these shares to the trail storage system 20. The trail storage system 20 restores a hash value h(x) of the data x from the shares a₁, a₂, and a₃ of the hash values h(x) of the data x. The trail storage system 20 restores a hash value h(x∥R) of the data x from the shares b₁, b₂, and b₃ of the hash values h(x∥R). h(x) represents a value obtained by inputting x to a predetermined hash function, and represents concatenation of data.

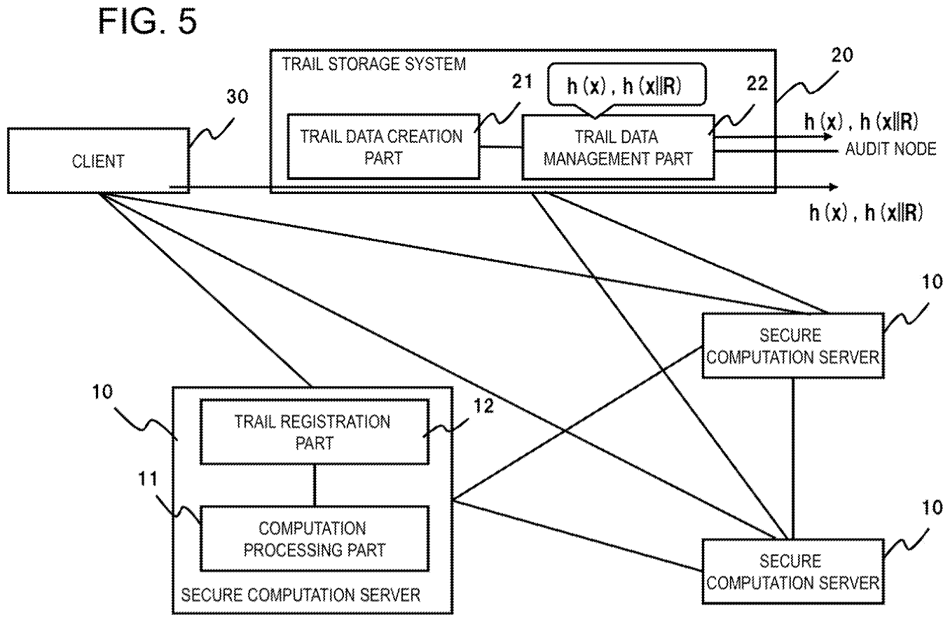

Next, when the trail storage system 20 receives an audit request about the data x and the computation result R from the predetermined audit node, the trail storage system 20 transmits the hash value h(x) and the hash value h(x∥R) to the audit node as illustrated in FIG. 5. The audit node requests the client 30 to transmit the hash value h(x) and the hash value h(x∥R) and determines whether the hash values h(x) match and whether the hash values h(x∥R) match. In this way, the audit node can determine whether the client 30 has conducted data replacement. For example, if the hash values h(x) do not match, the audit node determines that the client 30 has replaced the hash value h(x). Likewise, if the hash values h(x∥R) do not match, the audit node determines that the client 30 has replaced the computation result R.

As described above, according to the present example embodiment, a mechanism of detecting the correctness of secure computation target data is established, and the reliability of the secure computation system that obtains a desired computation result while protecting privacy can be improved. In the above example, the present invention has been applied to secure computation performed by three parties, the method for creating the first and second trail data may be changed depending on the secure computation method to be adopted. For example, when n parties perform secure computation, n secure computation servers transmit n shares a₁ to aₙ, and the trail storage system creates the first and second trail data from these shares. Likewise, when a homomorphic encryption method is used as the secure computation method, Enc(h(x)) and Enc(h(x∥R)) can be created from the data x and the computation result R and can be used as the first and second trail data. Enc(x) indicates encrypted text based on the homomorphic encryption method.

### First Example Embodiment

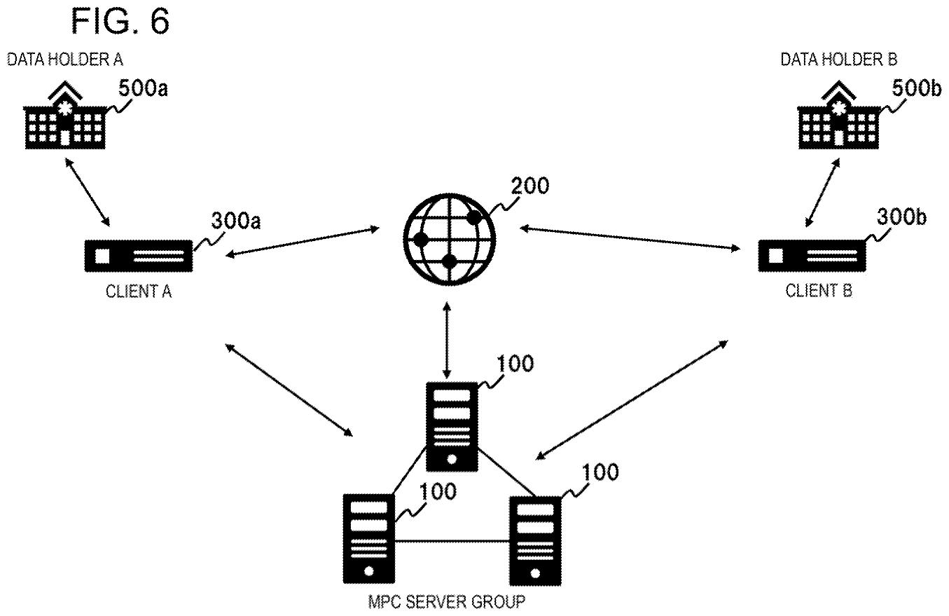

Next, a first example embodiment will be described in detail with reference to drawings. In the first example embodiment, the present invention is applied to a mode in which secure computation is performed by receiving data from a plurality of clients. FIG. 6 is a drawing illustrating a configuration according to the first example embodiment of the present invention. In the configuration illustrated in FIG. 6, an MPC server group constituted by three MPC servers 100, a trail storage system 200, a client 300a, and a client 300b are connected to each other.

The following description assumes that the client 300a is an apparatus of an information bank A (a client A) that manages secret target data x and that the client 300b is an apparatus of an information bank B (a client B) that manages secret target data y. The three MPC servers 100 receive shares of data x and shares of data y from the clients 300a and 300b and calculate computation results R in coordination with each other. The three MPC servers 100 transmit shares of the computation results R to the client 300a or the client 300b. The client 300a or the client 300b can restore a computation result R from the shares of the computation results R and can use the restored computation result R. In the following example embodiment, the trail storage system 200 is used to detect data replacement or the like conducted by the client 300a or the client 300b.

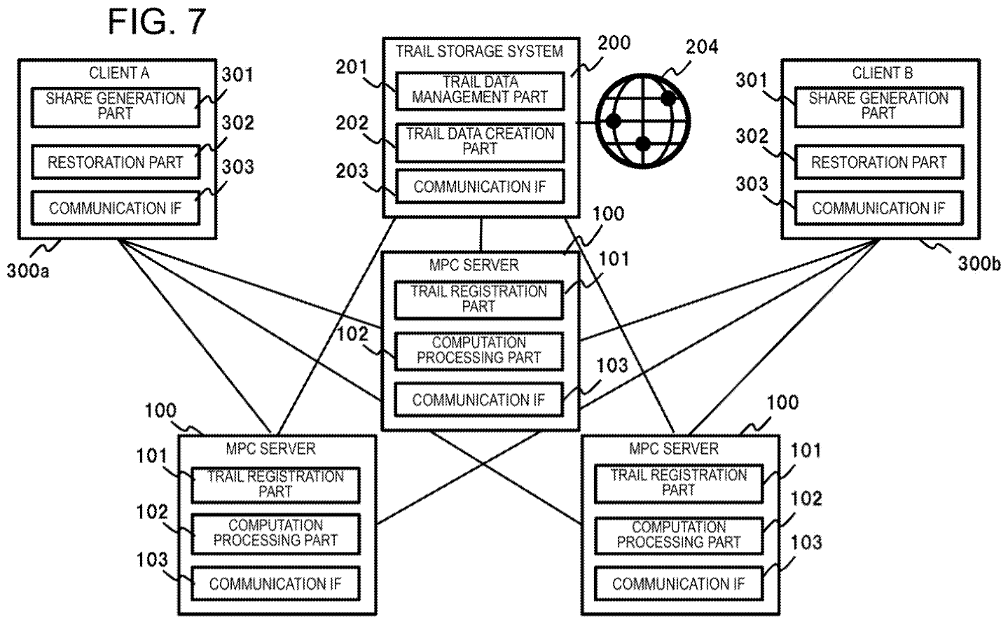

FIG. 7 is a functional block diagram illustrating a detailed configuration according to the first example embodiment of the present invention. As illustrated in FIG. 7, each of the clients 300a and 300b includes a share generation part 301, a restoration part 302, and a communication interface (communication IF) 303.

The share generation part 301 generates shares (secret data) by applying a secret sharing method to the data (data x or data y) received from a data holder and transmits the shares to the MPC servers 100 via the communication IF 303. As this secret sharing method, it is possible to use a (k,n) threshold method. In this method, first, an inputted plain text is divided into n partition values, and next these n partition values are distributed to n computation nodes (MPC servers 100). The plain text can be restored if an arbitrary number k of partition values are obtained. Of course, any of the methods disclosed in the above PTLs and NPLs may alternatively be used.

The restoration part 302 restores the computation result R from the shares of the computation results R received from the MPC servers 100 via the communication IF 303.

Each of the MPC servers 100 includes a trail registration part 101, a computation processing part 102, and a communication IF 103. The individual computation processing part 102 computes a share of a computation result R by using a share (secret data) received from the client 300a or 300b via the communication IF 103 and transmits the computed share to the client 300a or the client 300b.

The individual trail registration parts 101 transmit, to the trail storage system 200, shares (ha₁, ha₂, and ha₃) of the hash values of their respective data x, shares (hb₁, hb₂, and hb₃) of the hash values of their respective data y, and shares of their respective hash values h(x∥R) and h(y∥R). The shares of the hash values h(x∥R) will be referred to as (hc₁, hc₂, and hc₃), and the shares of the hash values h(y∥R) will be referred to as (hd₁, hd₂, and hd₃).

The trail storage system 200 includes a trail data management part 201, a trail data creation part 202, and a communication IF 203 and can store data in a blockchain 204.

The trail data creation part 202 creates trail data from the shares received from the MPC servers 100 via the communication IF 203. Specifically, the trail data creation part 202 computes a hash value h(x) of the data x from the shares of the hash values of the data x and uses the hash value h(x) as the trail data of the data x. The following description assumes that h(x) is a value obtained by inputting the data x to a hash function and satisfies a feature that it is difficult to compute x from h(x). The following description assumes that h(x) can be computed from an operation on the shares ha₁, ha₂, and ha₃, for example, from ha₁+ha₂+ha₃.

Likewise, the trail data creation part 202 computes a hash value h(y) of the data y from the shares hb₁, hb₂, and hb₃ of the hash values of the data y and uses the hash value h(y) as the trail data of the data y. In addition, the trail data creation part 202 computes a hash value h(x∥R) from the shares (hc₁, hc₂, and hc₃) of the hash value h(x∥R). Likewise, the trail data creation part 202 computes a hash value h(y∥R) from the shares (hd₁, hd₂, and hd₃) of the hash values h(y∥R). The following description also assumes that a symbol ab indicates concatenation of data a and data b.

The trail data management part 201 stores the hash values h(x), h(y), h(x∥R), and h(y∥R) in the blockchain 204.

The blockchain 204 is a distributed ledger technology for storing data by concatenating blocks in which data is stored in the form of a chain or the like. In the present example embodiment, the above hash values h(x), h(y), h(x∥R), and h(y∥R) are stored in a block, and an arbitrary set of h(x), h(y), h(x∥R), and h(y∥R) can be extracted.

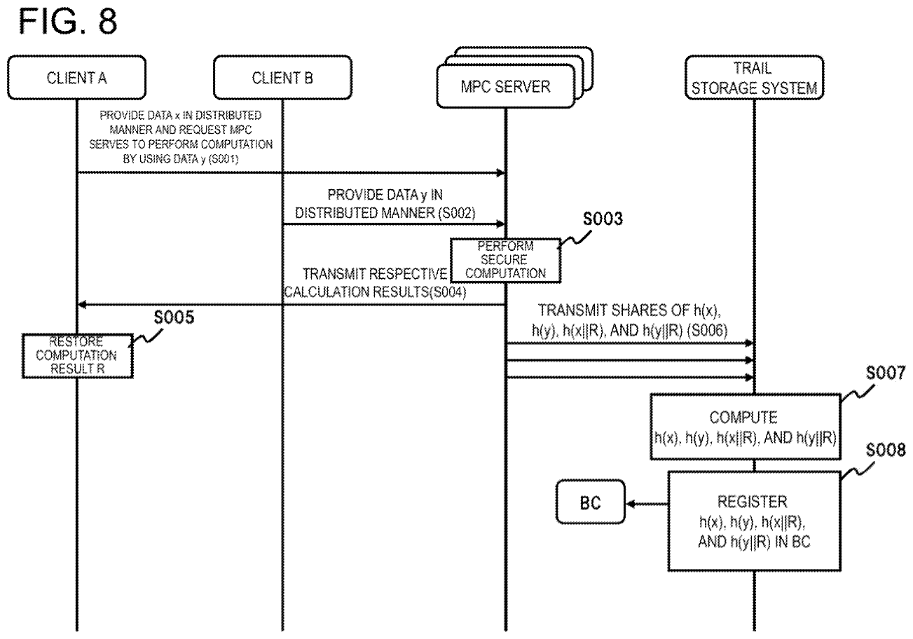

Next, an operation according to the present example embodiment will be described in detail with reference to drawings. FIG. 8 is a sequence diagram illustrating an operation according to the first example embodiment of the present invention. The following description assumes that the data holder A previously transmits a signature sig(x) to the client 300a along with the data x and that the data holder A and the client 300a have determined that there is no falsification or the like. Likewise, the following description assumes that the data holder B previously transmits a signature sig(y) to the client 300b along with the data y and that the data holder B and the client 300b have determined that there is no falsification or the like.

As illustrated in FIG. 8, the client 300a generates shares x₁, x₂, and x₃ from the data x, transmits these shares x₁, x₂, and x₃ to the MPC servers 100, and requests the MPC servers 100 to perform secure computation by combining the data x with the data y (step S001). An example of this secure computation using the data x and the data y is an example in which purchase data of a single person who visited different stores is compared with each other and some statistical information is calculated.

The client 300b generates shares y₁, y₂, and y₃ from the data y and transmits the shares y₁, y₂, and y₃ to the MPC servers 100 (step S002).

One of the MPC servers 100 computes a computation result R₁ from the share x₁ and the share y₁. Likewise, the other two MPC servers 100 calculate computation results R₂ and R₃ from the share x₂, the share y₂, the share x₃, and the share y₃ (step S003). In addition, the three MPC servers 100 transmit the computation results R₁, R₂, and R₃ to the client A (step S004).

The client A restores a computation result R from the computation results R₁, R₂, and R₃ and provides the restored computation result R to a data holder 500a (step S005). The processing performed so far is the same as the secure computation using the MPC servers.

Next, the MPC servers 100 compute shares (ha₁, ha₂, and ha₃) of the hash values h(x) of their respective data x and shares (hb₁, hb₂, and hb₃) of the hash values h(y) of their respective data y. In addition, the MPC server 100 computes shares (hc₁, hc₂, and hc₃) and (hd₁, hd₂, and hd₃) of the hash values h(x∥R) and h(y∥R) and transmits these shares to the trail storage system 200 (step S006).

The trail storage system 200 computes hash values h(x) and h(y) from the received shares ha₁, ha₂, and ha₃ and the received shares hb₁, hb₂, and hb₃. In addition, the trail storage system 200 computes a hash value h(x∥R) from the received shares (hc₁, hc₂, and hc₃) of the hash values h(x∥R). In addition, the trail storage system 200 computes a hash value h(y∥R) from the received shares (hd₁, hd₂, and hd₃) of the hash value h(y∥R) (step S007). Finally, the trail storage system 200 stores the computed hash values h(x), h(y), h(x∥R), and h(y∥R) in the blockchain 204 (step S008).

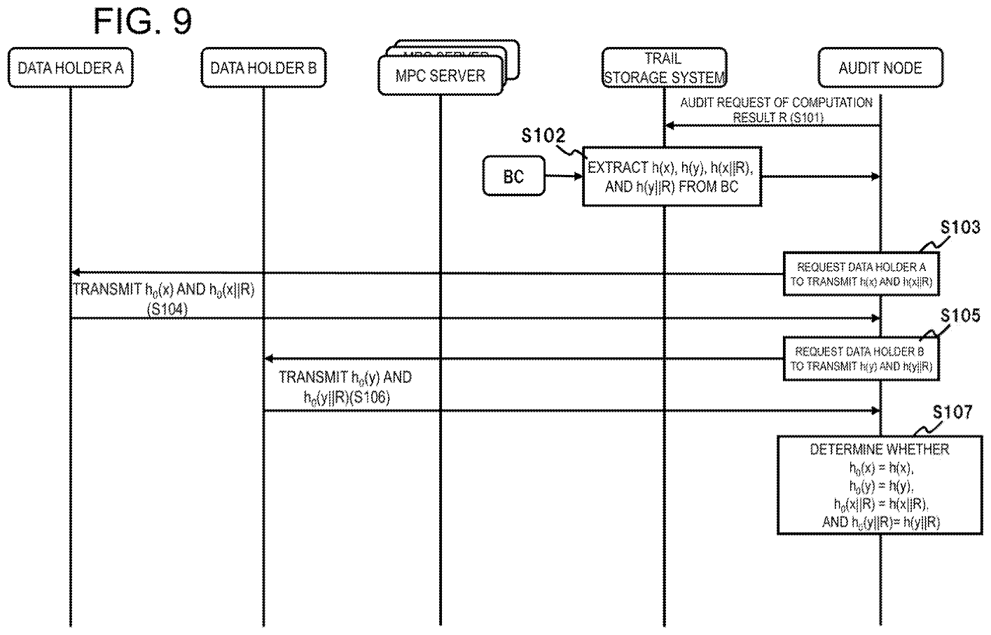

Next, an audit process using data registered in the above trail storage system 200 will be described. The following description assumes that the data holder 500a, the data holder 500b, or a third party has transmitted, to an auditor (an audit node), an audit request about the correctness of a computation result R. FIG. 9 is a sequence diagram illustrating an operation (an audit process) according to the first example embodiment of the present invention.

As illustrated in FIG. 9, first, the audit node requests the trail storage system 200 to transmit trail data (step S101). The audit node may indicate the target computation result R so that the trail storage system 200 can determine the corresponding trail data being requested.

When receiving the trail data transmission request, the trail storage system 200 extracts the corresponding hash values h(x), h(y), h(x∥R), and h(y∥R) from the blockchain 204 and transmits these hash values to the audit node (step S102).

Next, the audit node requests the data holder 500a to transmit the hash value h(x) of the data x and the hash value h(x∥R) of a value x∥R in which the data x and the computation result R are concatenated (step S103).

When receiving the request, the data holder 500a computes the hash value h(x) of the data x and the hash value h(x∥R) and transmits these hash values to the audit node (step S104). The hash values h(x) and h(x∥R) created by the data holder 500a will be referred to as h₀(x) and h₀(x∥R), respectively. In addition, as described above, since h(x) satisfies a feature that it is difficult to compute x from h(x), x is not leaked to the audit node.

Next, the audit node requests the data holder 500b to transmit the hash value h(y) of the data y and the hash value h(y∥R) of the value y∥R in which the data y and the computation result R are concatenated (step S105).

When receiving the request, the data holder 500b computes the hash value h(y) of the data y and the hash value h(y∥R) and transmits these hash values to the audit node (step S106). The hash values h(y) and h(y∥R) created by the data holder 500b will be referred to as h₀(y) and h₀(y∥R), respectively. In addition, as described above, since h(y) satisfies a feature that it is difficult to compute y from h(y), y is not leaked to the audit node.

Finally, the audit node determines the correctness of the computation result R by determining whether the following values (1) to (4) match (step S107).

h(x)=h₀(x) (1)

h(y)=h₀(y) (2)

h(x∥R)=h₀(x∥R) (3)

h(y∥R)=h₀(y∥R) (4)

If the above (1) h(x)=h₀(x) is not met, the audit node determines that the client 300a has replaced the data x. This is because h(x) is computed from the shares (for example, ha₁, ha₂, and ha₃) that the trail storage system 200 has received from the MPC servers 100, h(x) is stored in the blockchain 204, and the identity is guaranteed. In addition, in this case, (3) h(x∥R)=h₀(x∥R) is not met, either.

If the above (2) h(y)=h₀(y) is not met, the audit node determines that the client 300b has replaced the data y. This is because h(y) is computed from the shares (for example, hb₁, hb₂, and hb₃) that the trail storage system 200 received from the MPC servers 100, h(y) is stored in the blockchain 204, and the identity is guaranteed. In addition, in this case, (4) h(y∥R)=h₀(y∥R) is not met, either.

If (1) h(x)=h₀(x) is met and (3) h(x∥R)=h₀(x∥R) is not met, the audit node determines that the client 300a has replaced the computation result R.

Likewise, if (2) h(y)=h₀(y) is met and (4) h(y∥R)=h₀(y∥R) is not met, the audit node determines that the client 300b has replaced the computation result R.

As described above, according to the present example embodiment, even when secure computation target data is provided by a plurality of holders, the correctness of the data can be determined. The order of steps S101 and S102, the order of steps S103 and S104, and the order of steps S105 and S106 in FIG. 9 are not limited to those illustrated in FIG. 9. An individual pair of steps may be suitably switched.

### Second Example Embodiment

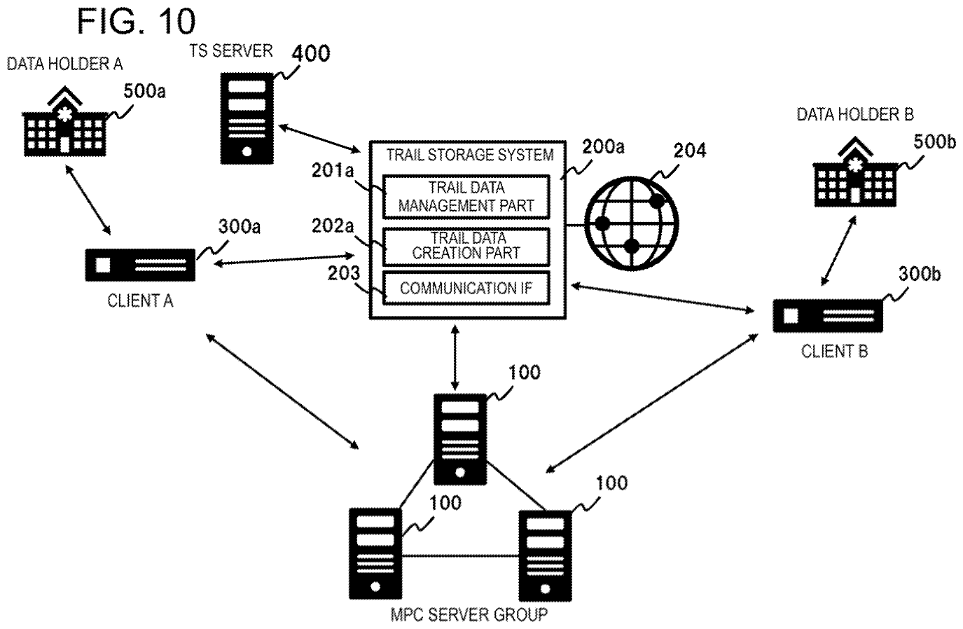

Next, a second example embodiment will be described in detail with reference to drawings. Unlike the first example embodiment, the second example embodiment can certify that trail data exists and that the trail data has not been falsified. FIG. 10 is a drawing illustrating a configuration according to the second example embodiment of the present invention. The second example embodiment differs from the first example embodiment illustrated in FIGS. 6 and 7 in that a time stamp server (TS server) 400 is added and that a time stamp is used to create trail data. Since other aspects of the configuration according to the second example embodiment are the same as those according to the first example embodiment, the following description will be made with a focus on the difference.

The time stamp server (TS server) 400 is a server that adds time stamps to hash values in response to requests from clients based on a method as typified by RFC 3161.

When a trail data creation part 202a of a trail storage system 200a according to the second example embodiment creates trail data from shares received from MPC servers 100 via a communication IF 203, the trail data creation part 202a uses a time stamp T received from the TS server 400. Specifically, the trail data creation part 202a acquires a time stamp T for a hash value h(x) from the TS server 400, computes a hash value h′(h(x)∥T) by using a second hash function h′(x), and uses this hash value h′(h(x)∥T) as the trail data of data x.

Likewise, the trail data creation part 202a acquires a time stamp T for a hash value h(y), computes a hash value h′(h(y)∥T) by using the second hash function h′(y), and uses this hash value h′(h(y)∥T) as the trail data of data y.

Next, the trail data creation part 202a enters a value in which the hash value h′(h(x)∥T) and a corresponding computation result R are concatenated to a third hash function h″(x) and computes a hash value h″(h′(h(x)∥T)∥R) as the trail data indicating a correlation between the data x and the computation result R. Likewise, the trail data creation part 202a enters a value in which the hash value h′(h(y)∥T) and a corresponding computation result R are concatenated to the third hash function h″(x) and computes a hash value h″(h′(h(y)∥T)∥R) as the trail data indicating a correlation between the data y and the computation result R.

A trail data management part 201a stores these hash values h′(h(x)∥T), h′(h(y)∥T), h″(h′(h(x)∥T)∥R), and h″(h′(h(y)∥T)∥R) in a blockchain 204.

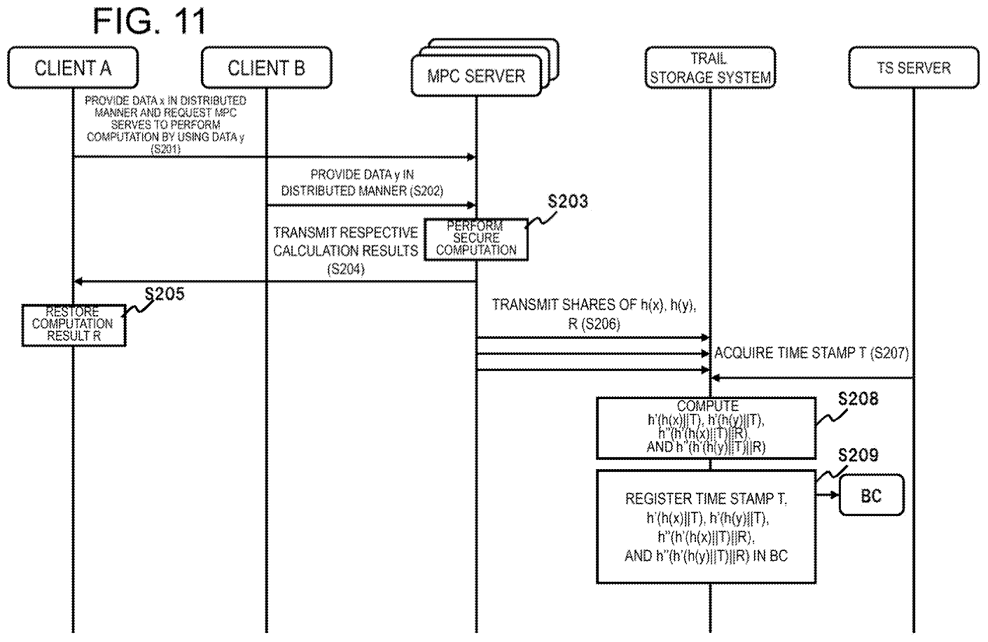

Next, an operation according to the present example embodiment will be described in detail with reference to drawing. FIG. 11 is a sequence diagram illustrating an operation according to the second example embodiment of the present invention. Since the operation from steps S201 to S206 is the same as that from steps S001 to S006 in FIG. 8 according to the first example embodiment, the description of steps S201 to S206 will be omitted.

After the trail storage system 200a restores a hash value h(x), a hash value h(y), and a computation result R from shares ha₁, ha₂, and ha₃, shares hb₁, hb₂, and hb₃, and shares R₁, R₂, and R₃, the trail storage system 200a acquires a time stamp T from the TS server 400 (step S207).

Next, the trail storage system 200a computes hash values h′(h(x)∥T), h′(h(y)∥T), h″(h′(h(x)∥T)∥R), and h″(h′(h(y)∥T)∥R) (step S208).

Finally, the trail storage system 200a stores these hash values h′(h(x)∥T), h′(h(y)∥T), h″(h′(h(x)∥T)∥R), and h″(h′(h(y)∥T)∥R) in the blockchain 204 (step S209).

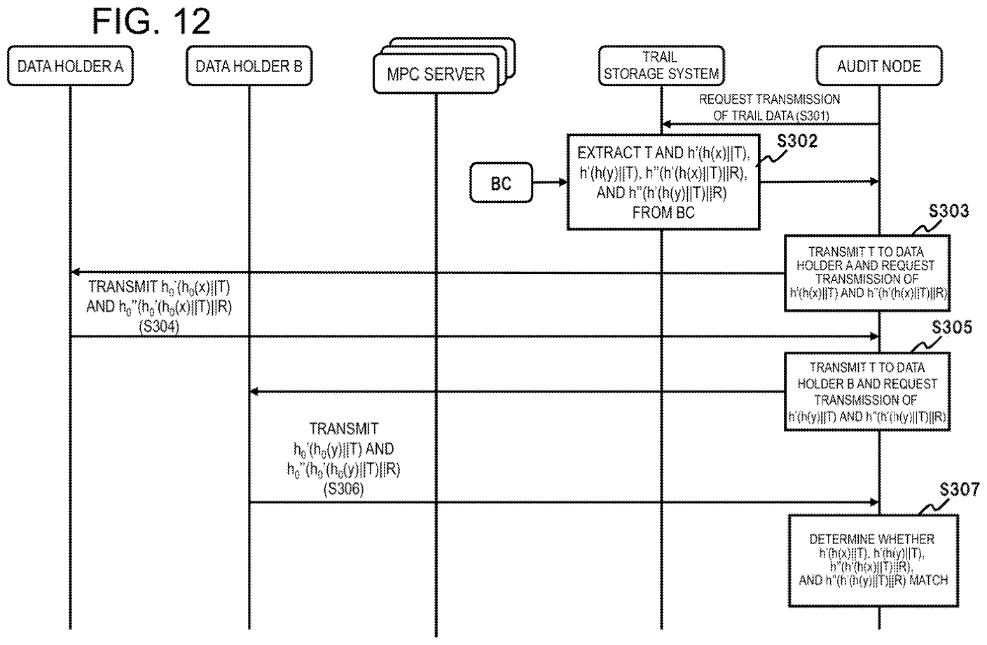

Next, an audit process using data registered in the above trail storage system 200a will be described. The following description assumes that a data holder 500a, a data holder 500b, or a third party has transmitted an audit request about the correctness of a computation result R to an auditor (an audit node). FIG. 12 is a sequence diagram illustrating an operation (an audit process) according to the second example embodiment of the present invention.

As illustrated in FIG. 12, first, the audit node requests the trail storage system 200a to transmit trail data (step S301). The audit node may indicate the target computation result R so that the trail storage system 200a can determine the corresponding trail data being requested.

When receiving the trail data transmission request, the trail storage system 200a extracts the corresponding time stamp T and hash values h′(h(x)∥T), h′(h(y)∥T), h″(h′(h(x)∥T)∥R), and h″(h′(h(y)∥T)∥R) from the blockchain 204 and transmits the extracted time stamp T and hash values to the audit node (step S302).

Next, the audit node transmits the time stamp T to the data holder 500a and requests the data holder 500a to transmit corresponding hash values h′(h(x)∥T) and h″(h′(h(x)∥T)∥R) (step S303).

When receiving the request, the data holder 500a computes hash values h₀′(h₀(x)∥T) and h₀″(h₀′(h₀(x)∥T)∥R) by using the time stamp T and hash functions h(x), h′(x), and h″(x) and transmits the calculated hash values to the audit node (step S304). Hereinafter, the hash value h(x) calculated by the data holder 500a and the data holder 500b will be denoted as h₀(x) by adding an index 0 is added to h(x). In addition, h₀′(h₀(x)∥T) is a hash value of a value in which the hash value h₀(x) of the data x and T are concatenated, based on h₀′(x). In addition, h₀″(h₀′(h₀(x)∥T)∥R) is a hash value of a value in which the hash value h₀′(h₀(x)∥T) and the computation result R are concatenated, based on h₀″(x).

Next, the audit node transmits the time stamp T to the data holder 500b and requests the data holder 500b to transmit corresponding hash values h′(h(y)∥T) and h″(h′(h(y)∥T)∥R) (step S305).

When receiving the request, the data holder 500b computes hash values h₀′(h₀(y)∥T) and h₀″(h₀′(h₀(y)∥T)∥R) by using the time stamp T and hash functions h(x), h′(x), and h″(x) and transmits the calculated hash values to the audit node (step S306).

Finally, the audit node determines the correctness of the computation result R by determining whether the following values (1) to (4) match (step S307).

h′(h(x)∥T)=h₀′(h₀(x)∥T) (1)

h′(h(y)∥T)=h₀′(h₀(y)∥T) (2)

h″(h′(h(x)∥T)∥R)=h₀″(h₀′(h₀(x)∥T)∥R) (3)

h″(h′(h(y)∥T)∥R)=h₀″(h₀′(h₀(y)∥T)∥R) (4)

If the above (1) h′(h(x)∥T)=h₀′(h₀(x)∥T) is not met, the audit node determines that the client 300a has replaced the data x. This is because the individual hash values are computed from the shares (for example, a₁, a₂, and a₃) that the trail storage system 200a has received from the MPC servers 100, these hash values are stored in the blockchain 204, and the identity is guaranteed. In addition, in this case, (3) h″(h′(h(x)∥T)∥R)=h₀″(h₀′(h₀(x)∥T)∥R) is not met, either.

If the above (2) h′(h(y)∥T)=h₀′(h₀(y)∥T) is not met, the audit node determines that the client 300b has replaced the data y. This is because the individual hash values are computed from the shares (for example, b₁, b₂, and b₃) that the trail storage system 200a has received from the MPC servers 100, these hash values are stored in the blockchain 204, and the identity is guaranteed. In addition, in this case, (4) h″(h′(h(y)∥T)∥R)=h₀″(h₀′(h₀(y)∥T)∥R) is not met, either.

If (1) h′(h(x)∥T)=h₀′(h₀(x)∥T) is met and (3) h″(h′(h(x)∥T)∥R)=h₀″(h₀′(h₀(x)∥T)∥R) is not met, the audit node determines that the client 300a has replaced the computation result R.

Likewise, if (2) h′(h(y)∥T)=h₀′(h₀(y)∥T) is met and (4) h″(h′(h(y)∥T)∥R)=h₀″(h₀′(h₀(y)∥T)∥R) is not met, the audit node determines that the client 300b has replaced the computation result R.

As described above, according to the present example embodiment, in addition to the advantageous effects of the first example embodiment, whether the same data has been used for computation at a certain time point T and for computation at a different time point T′ can be kept secret. This is because, by including a time point T in a hash value, even when the same data is used at different time points, different hash values are generated at these different time points.

While example embodiments of the present invention have thus been described, the present invention is not limited thereto. Further variations, substitutions, or adjustments can be made without departing from the basic technical concept of the present invention. For example, the configurations of the networks, the configurations of the elements, and the representation modes of the messages illustrated in the drawings have been used only as examples to facilitate understanding of the present invention. That is, the present invention is not limited to the configurations illustrated in the drawings.

For example, while the above example embodiments assume that trail data is created by using a hash function, a different one-way function may alternatively be used, as long as a feature that trail data can be computed from data x and it is difficult to compute the data x from the trail data is satisfied. In addition, the hash functions h(x), h′(x), and h″(x) may be the same hash function or different hash functions.

For example, while the above example embodiments have been described based on an example in which the data holder 500a provides the data x and the data holder 500b provides the data y, the application field of the present invention is not limited to this example. For example, the present invention is applicable without problem to a case in which a third data holder registers a learning model M or the like in an information bank and the MPC servers 100 are requested to perform secure computation on data by using the learning model M. In this case, too, whether all the data holders have provided correct data and whether the learning model M has been provided can be verified.

In addition, the individual example embodiment described above assumes that the trail storage system 200 or 200a restores the hash values of the data x and the data y and the computation result R and generates the trail data. However, it is possible to adopt a configuration including an intermediate node that restores the hash values of the data x and the data y and the computation result R and creates the trail data.

In addition, while the example embodiments assume that the blockchain 204 is used as a trail data storage destination, a different storage apparatus in which data can be stored in a non-rewritable manner may alternatively be used.

In addition, the above example embodiments use an example in which the present invention is applied to a configuration in which three MPC servers perform multi-party computation, the secure computation method to which the present invention is applicable is not limited to this example. For example, the present invention is also applicable to a configuration in which n MPC servers perform multi-party computation. In this case, n secure computation servers transmit n shares a₁ to aₙ, and the trail storage system creates first and second trail data from these shares. Likewise, when a homomorphic encryption method is used as the secure computation method, encrypted text Enc(h(x)), Enc(h(y)), Enc(h(x∥R)), and Enc(h(y∥R)) can be created from data x, data y, and the corresponding computation results R as the first and second trail data.

In addition, the method for computing the first and second trail data in the individual example embodiment described above is only an example. Any of various methods may be used as the creation method. For example, in place of h(x) and h(x∥R), h(x∥S) and h(x∥R∥S) obtained by concatenating an arbitrary string S to x and x∥R may be used. Likewise, in place of h(x) and h(x∥R), h(p(x)) and h(p(x∥R)) may be used by using an arbitrary replacement function p(x). Likewise, replacement data of the encrypted text Enc(h(x)), Enc(h(y)), Enc(h(x∥R)), and Enc(h(y∥R)) may be used as the first and second trail data.

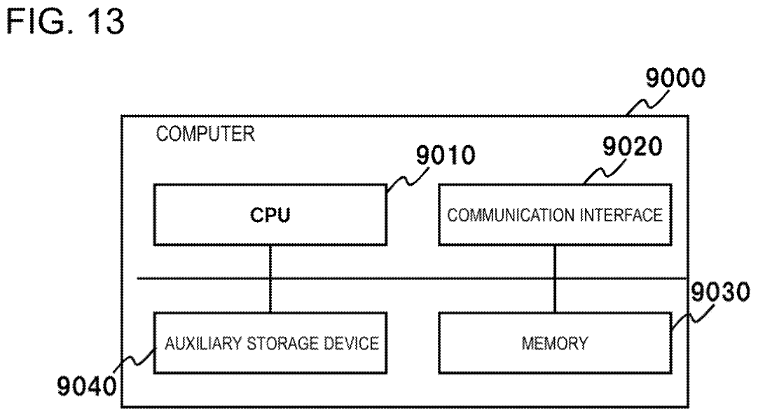

The procedure according to the first or second example embodiment can be realized by a program that causes a computer (9000 in FIG. 13) serving as the MPC server 100, the trail storage system 200, or the trail storage system 200a to realize the function as this corresponding apparatus. For example, the computer includes a CPU (Central Processing Unit) 9010, a communication interface 9020, a memory 9030, and an auxiliary storage device 9040 in FIG. 13. That is, the program may cause the CPU 9010 in FIG. 13 to execute a share transmission program or a trail data creation program and to perform processing for updating individual computation parameters stored in the corresponding auxiliary storage device 9040 or the like.

That is, an individual unit (processing means, function) of the MPC server 100, the trail storage system 200, or the trail storage system 200a according to the above first or second example embodiment can be realized by a computer program that causes a processor mounted on this corresponding apparatus to execute the corresponding processing described above by using its hardware.

Finally, suitable modes of the present invention will be summarized.

### [Mode 1]

(See the secure computation server according to the above first aspect)

### [Mode 2]

The trail storage system store the first and second trail data by using a blockchain.

### [Mode 3]

The trail storage system store, as the first trail data, a hash value of the data x and store, as the second trail data, a hash value of a value in which the data x and the computation result R are concatenated.

### [Mode 4]

The trail storage system store, as the first trail data, a hash value of a value created by using the data x and a time stamp value and store, as the second trail data, a hash value of a value created by using the data x, the computation result R, and a time stamp value.

### [Mode 5]

The computation processing part of the secure computation server perform multi-party computation in which secure computation is performed in coordination with other secure computation servers, and the trail registration part of the secure computation server transmit, to the trail storage system, data for restoring the first trail data and the second trail data in a form of shares calculated by the computation processing part.

### [Mode 6]

(See the trail storage system according to the above second aspect)

### [Mode 7]

It is preferable that the trail data management part of the trail storage system be constituted by a blockchain.

### [Mode 8]

The trail data creation part of the trail storage system compute, as the first trail data, a hash value of the data x and compute, as the second trail data, a hash value of a value in which the data x and the computation result R are concatenated.

### [Mode 9]

The trail data creation part of the trail storage system compute, as the first trail data, a hash value of a value created by using the data x and a time stamp value and compute, as the second trail data, a hash value of a value created by using the data x, the computation result R, and a time stamp value.

### [Mode 10]

The individual secure computation server perform multi-party computation in which secure computation is performed in coordination with other secure computation servers. In addition, the trail data creation part of the trail storage system receive, from the individual secure computation servers, data for restoring the first trail data and the second trail data in a form of shares calculated by the multi-party computation and restore the first trail data and the second trail data.

### [Mode 11]

(See the secure computation trail management method according to the above third and fourth aspects)

### [Mode 12]

(See the program according to the above fifth aspect)

The above modes 11 and 12 can be expanded in the same way as mode 1 can be expanded to modes 2 to 5 and mode 6 can be expanded to modes 7 to 10.

The disclosure of each of the above PTLs and NPLs is incorporated herein by reference thereto and may be used as the basis or a part of the present invention as needed. Modifications and adjustments of the example embodiments and examples are possible within the scope of the overall disclosure (including the claims) of the present invention and based on the basic technical concept of the present invention. Various combinations and selections (including partial deletion) of various disclosed elements (including the elements in each of the claims, example embodiments, examples, drawings, etc.) are possible within the scope of the disclosure of the present invention. That is, the present invention of course includes various variations and modifications that could be made by those skilled in the art according to the overall disclosure including the claims and the technical concept. The description discloses numerical value ranges. However, even if the description does not particularly disclose arbitrary numerical values or small ranges included in the ranges, these values and ranges should be deemed to have been specifically disclosed.

### REFERENCE SIGNS LIST

10 secure computation server
11, 102 computation processing part
12, 101 trail registration part
20, 200, 200a trail storage system
21, 202, 202a trail data creation part
22, 201, 201a trail data management part
30, 300a, 300b client
100 MPC server
400 TS server
500a, 500b data holder
301 share generation part
302 restoration part
103, 203, 303 communication interface (communication IF)
204 blockchain
9000 computer
9010 CPU
9020 communication interface
9030 memory
9040 auxiliary storage device

What is claimed is:

1. A secure computation server, comprising:
a computation processor that performs secure computation of a computation result R by using data x received from a client; and
a trail registration part that makes a predetermined trail storage system store first trail data and second trail data, wherein the first trail data is calculated from the data x for certifying identity of the data x and the second trail data certifies a relationship between the data x and the computation result R.

2. The secure computation server according to claim 1; wherein the predetermined trail storage system stores the first and second trail data by using a blockchain.

3. The secure computation server according to claim 1; wherein the predetermined trail storage system stores, as the first trail data, a hash value of the data x and stores, as the second trail data, a hash value of a value in which the data x and the computation result R are concatenated.

4. The secure computation server according to claim 1; wherein the predetermined trail storage system stores, as the first trail data, a hash value of a value created by using the data x and a time stamp value and stores, as the second trail data, a hash value of a value created by using the data x, the computation result R, and a time stamp value.

5. The secure computation server according to claim 1;
wherein the computation processor processing part performs multi-party computation in which secure computation is performed in coordination with other secure computation servers; and
wherein the trail registration part transmits, to the trail storage system, data for restoring the first trail data and the second trail data in a form of shares calculated by the computation processing part.

6. A trail storage system, comprising:
a trail data creation part that creates first trail data for certifying identity of the data x and second trail data for certifying a relationship between data x and computation result R, based on data received from secure computation servers; and
a trail data management part that manages the first and second trail data in a non-rewritable manner and provides the first and second trail data to a predetermined audit node,
wherein each of the secure computation servers performs secure computation of the computation result R by using the data x received from a client and a trail registration part that makes a predetermined trail storage system store first trail data and second trail data,
wherein the first trail data is calculated from the data x for certifying identity of the data x and the second trail data certifies a relationship between the data x and the computation result R.

7. The trail storage system according to claim 6; wherein the trail data management part is constituted by a blockchain.

8. The trail storage system according to claim 6; wherein the trail data creation part computes, as the first trail data, a hash value of the data x and computes, as the second trail data, a hash value of a value in which the data x and the computation result R are concatenated.

9. The trail storage system according to claim 6; wherein the trail data creation part computes, as the first trail data, a hash value of a value created by using the data x and a time stamp value and computes, as the second trail data, a hash value of a value created by using the data x, the computation result R, and a time stamp value.

10. The trail storage system according to claim 6;
wherein the individual secure computation server perform multi-party computation in which secure computation is performed in coordination with other secure computation servers; and
wherein the trail data creation part receives, from the individual secure computation servers, data for restoring the first trail data and the second trail data in a form of shares calculated by the multi-party computation.

11. A secure computation trail management method, comprising:
causing a secure computation server to transmit data for computing first trail data for certifying identity of data x and second trail data for certifying a relationship between the data x and computation result R to a predetermined trail storage system; and
causing the predetermined trail storage system to store the first trail data and the second trail data,
wherein the secure computation server performs secure computation of the computation result R by using the data x received from a client.

12. A secure computation trail management method, comprising:
receiving data for computing first trail data for certifying identity of the data x and second trail data for certifying a relationship between the data x and the computation result R from a secure computation server performs secure computation of the computation result R by using data x received from a client;
creating the first trail data and the second trail data based on the received data; and
managing the first trail data and the second trail data in a non-rewritable manner and providing the first trail data and the second trail data to a predetermined audit node.

13. A non-transient computer readable medium storing a program causing a secure computation server to perform:
secure computing a computation result R by using data x received from a client and computes;
transmitting data for computing first trail data for certifying identity of the data x and second trail data for certifying a relationship between the data x and the computation result R to a predetermined trail storage system; and
causing the predetermined trail storage system to store the first trail data and the second trail data.

14. (canceled)

15. The secure computation trail management method according to claim 11; wherein the predetermined trail storage system stores the first and second trail data by using a blockchain.

16. The secure computation trail management method according to claim 11; wherein the predetermined trail storage system stores, as the first trail data, a hash value of the data x and stores, as the second trail data, a hash value of a value in which the data x and the computation result R are concatenated.

17. The secure computation trail management method according to claim 11; wherein the predetermined trail storage system stores, as the first trail data, a hash value of a value created by using the data x and a time stamp value and stores, as the second trail data, a hash value of a value created by using the data x, the computation result R, and a time stamp value.

18. The secure computation trail management method according to claim 12; wherein the non-rewritable manner uses a blockchain.

19. The secure computation trail management method according to claim 12; wherein the first trail data is a hash value of the data x and the second trail data is a hash value of a value in which the data x and the computation result R are concatenated.

20. The secure computation trail management method according to claim 12; wherein the first trail data is a hash value of a value created by using the data x and a time stamp value and the second trail data is a hash value of a value created by using the data x, the computation result R, and a time stamp value.

21. The non-transient computer readable medium storing a program causing a secure computation server according to claim 13; wherein the predetermined trail storage system stores the first and second trail data by using a blockchain.
